(19) United States
(12) Patent Application Publication
(10) Pub. No.: US 2012/0276461 A1
(43) Pub. Date: Nov. 1, 2012

(54) Fuel Cell System Having a Fluid Separator in the Anode Circuit

(75) Inventors: Thomas Baur, Weilheim (DE); Holger Richter, Kirchheim (DE)

(73) Assignee: Daimler AG, Stuttgart (DE)

(21) Appl. No.: 13/509,952

(22) PCT Filed: Oct. 30, 2010
(86) PCT No.: PCT/EP2010/006638

§ 371 Date: Jul. 18, 2012

(30) Foreign Application Priority Data
Nov. 16, 2009 (DE) 10 2009 053 499.7

(51) Int. Cl. H01M 8/04; H01M 8/06

(52) U.S. Cl. 429/410

(57) ABSTRACT

A fuel cell system includes an anode circuit by means of which unused gas from the anode region of a fuel cell can be recirculated via a recirculation delivery device into the anode region. At least one liquid separator is provided in the anode circuit. The liquid separator is integrated with the recirculation delivery device to form an assembly. Fresh hydrogen is supplied to the anode region by feeding the hydrogen into the liquid separator.

### BACKGROUND AND SUMMARY OF THE INVENTION

The invention relates to a fuel cell system with an anode circuit.

From general prior art, it is known to provide anode circuits in fuel cell systems, by means of which anode circuits unused exhaust gas from the anode region of the fuel cell can be recirculated and then fed to the anode region of the fuel cell together with fresh hydrogen. To compensate for the pressure loss occurring in the anode region, a recirculation delivery device is required in the region of such an anode circuit. This may in principle consist of a fan, a compressor or the like. It would, however, be conceivable to design this device in such a way that the incoming fresh hydrogen draws the recirculated gas stream in the manner of a jet pump. A combination of such recirculation delivery devices is also conceivable.

Typically, however, a fan is used as recirculation delivery device. In order to operate such a fan safely and reliably and to prevent a freezing of liquid droplets in the region of the fan and thus a blocking of the fan impeller, in particular when stopping the system, PCT Published Application No. WO 2006/056276 A1 proposes providing liquid separators both upstream and downstream of the recirculation delivery device. These can then be inter-connected in such a way that the water separator located at a geodetically higher level introduces its separated water, for example, into the region of the second water separator or its inlet line. The fresh hydrogen in this design is supplied in the typical manner between the recirculation delivery device and the first water separator. This has the disadvantage that droplets tend to condensate out in the line section between these two components and may return into the region of the valve and/or the recirculation delivery device. If such a fuel cell system is now switched off at temperatures below freezing point, the condensed-out water may freeze, resulting in malfunction or leakage when the system is restarted.

German Patent Document No. DE 10 2007 033 203 A1 disclose integrating a separator with a recirculation delivery device to form an assembly. This is proposed in order to use the rotary motion of the recirculation delivery device for separating liquid droplets and in order to create as simple and efficient a configuration as possible. The specification describes a second, parallel, separator corresponding to the separator downstream of the recirculation delivery device as described in PCT Published Application No. WO 2006/056276 A1. The integration of the separator upstream of the recirculation delivery device in the direction of flow into the inflow region has the disadvantage that a great amount of water in involved, so that here, too, there is a risk of freezing.

Exemplary embodiments of the present invention are directed to a fuel cell system with an anode circuit that avoids the disadvantages described above and provides a simple, safe and reliably operating structure for the anode circuit.

In accordance with exemplary embodiments of the present invention, freshly supplied hydrogen is introduced into the region of the liquid separator so that any liquid remaining in the gas stream, which condenses out of the fresh and, owing to its expansion from a high pressure, typically very cold gas, condenses directly in the liquid separator and can therefore remain therein. In this configuration, the liquid separator is integrated with the recirculation delivery device. This prevents the feed of condensed-out liquid to line elements that could then freeze. The integration with the recirculation delivery device to form an integrated assembly further allows a very compact configuration to be obtained.

In a particularly useful and advantageous further development of the configuration according to the invention, the liquid separator integrated with the recirculation delivery device is placed downstream of the recirculation delivery device in the direction of flow of the recirculated gas stream. As a result, the freshly supplied hydrogen stream does not have to be routed through the recirculation delivery device, and the condensed-out water is primarily separated in the liquid separator.

In a correspondingly advantageous further development of the invention, a second liquid separator which is connected to the first liquid separator is provided in the anode circuit, the second liquid separator being located upstream of the recirculation delivery device in the direction of flow of the recirculated gas stream. As a result, only the liquid condensed out by the fresh hydrogen gas stream has to be separated in the first liquid separator, while the liquid discharged from the anode region can, for example, be separated out in the second separator. With this configuration, the product water, which will constitute the major part of separated water in the recirculated gas stream, can be separated before reaching the recirculation delivery device and therefore does not have to be conveyed through the recirculation delivery device in an energy-intensive manner. Downstream of the recirculation delivery device, the part of the liquid that has been condensed out owing to the fed-in fresh hydrogen and the temperature reduction involved is then separated in the liquid separator integrated with the recirculation delivery device, and the recirculation fan always runs dry, avoiding the risk of freezing. As the liquid separators are connected to each other, it is enough to discharge the water from the anode circuit using a single line element with a valve device, so that the need for interfaces—which are very sensitive to sealing problems, in particular with respect to the hydrogen feed—is reduced.

In a very advantageous and useful further development of the invention, both liquid separators can be integrated with the recirculation delivery device into an assembly, which provides a particularly compact configuration. Owing to the comparatively large mass of the integrated assembly, this will cool more slowly than the surrounding line elements, thereby minimizing the risk that liquid could condense out in the region of the assembly. In addition, further interfaces and line elements can be saved, which is a significant advantage in terms of costs and assembly work, in particular with respect to the interfaces which have to be sealed against the hydrogen present in the line elements.

The fuel cell system according to the invention can therefore be equipped with an anode circuit that operates reliably even at temperatures below freezing point and requires a minimum of interfaces and components. Such a simple, cost-effective and reliable configuration is predestined for use in a vehicle. The preferred application of the fuel cell system according to the invention is therefore the use of the fuel cell system in a vehicle for supplying electric energy to drive units and/or secondary loads.

Advantageous further developments of the fuel cell system according to the invention can be derived from the remaining dependent claims and will be illustrated with reference to the embodiment explained below with reference to the figures.

### BRIEF DESCRIPTION OF THE DRAWING FIGURES

Of the figures:

FIG. 1 is a highly diagrammatic view of a fuel cell system with an anode circuit comprising components according to the invention; and

FIG. 2 shows an embodiment of a liquid separator according to the invention.

### DETAILED DESCRIPTION

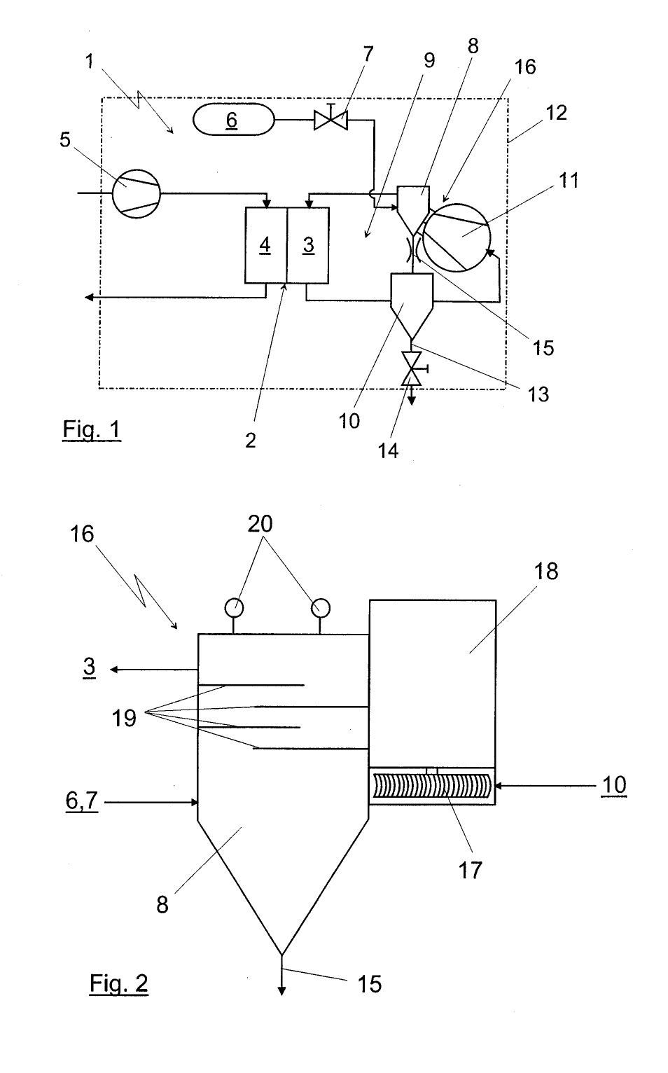

The illustration of FIG. 1 shows a fuel cell system 1, the core of which is a fuel cell 2 having an anode region 3 and a cathode region 4, and which may for example be a stack of PEM fuel cells. Air as an oxygen-containing gas is supplied to the cathode region 4 via an air delivery device 5. The air discharged from the cathode region 4 can be discharged to the environment either directly or via components not shown in the drawing, for example a burner, a turbine or the like.

The anode region 3 is supplied with hydrogen from a compressed-gas accumulator 6 in which the hydrogen is stored as a gas under high pressure. The hydrogen flows via a shut-off valve 7, in the region of which it is expanded, into a liquid separator 8 (described in detail below) and into the anode region 3. From the anode region 3, the unused residual gas flows in an anode circuit 9 via a second liquid separator 10 and a recirculation delivery device 11 into the region of the water trap 8 and can there flow back into the anode region 3 mixed with fresh hydrogen from the compressed-gas accumulator 6.

This highly simplified configuration of a fuel cell system 1 can, for example, be used in a vehicle 12, which is here only indicated diagrammatically, for supplying electric energy to its drive units and/or secondary loads.

A special feature of the configuration of the anode circuit 9 of the fuel cell system 1 according to FIG. 1 is the use of the two liquid separators 8, 10. The liquid separator 8 could also be called a water trap, while the second liquid separator 10 forms the main separator. Owing to the direction of flow of the recirculated gas stream in the anode circuit 9, the recirculated gas stream first reaches the main separator 10. In a fuel cell 2, the product water is primarily found in the cathode region 4 and discharged via the exhaust air. A part of the product water, however, is generated in the anode region 3 as well and is accordingly discharged via the recirculated gas stream. This water is now separated at the main separator 10 in order to prevent droplets from reaching the region of the recirculation delivery device 11, which is typically a recirculation fan. A line element 3 with a valve 14 leads into from the main separator 10 to the environment or into the supply air for the cathode region 4, so that the water collected in the main separator 10 can be discharged from time to time. The main separator 10 may further be provided with a known and commonly used splash guard, so that any water collected therein cannot flow back into the region of the lines of the anode circuit 9.

The water that has been freed of liquid droplets in the region of the main separator 10 in this way therefore reaches the recirculation delivery device 11 and from there the region of the water trap 8. In the region of the water trap 8, it is mixed with freshly supplied hydrogen from the compressed-gas accumulator 6. As the latter is comparatively cold owing to cooling in the expansion process, further water will condense out of the comparatively warm and moist gas stream downstream of the recirculation delivery device 11. This then collects in the region of the water trap 8, which may likewise be designed such that an entry of water can be prevented both backwards towards the recirculation delivery device 11 and forwards towards the anode region 3 by means of a suitable splash guard 19 or the like. As FIG. 1 further shows, a connection 15 is provided between the water trap 8 and the main separator 10. This connection 15 may in particular have a narrowing cross-section in order to avoid or minimize a flow of the compressed gas back into the region of the main separator. Via the connection 15, however, the water collecting in the water trap 8 can be discharged into the main separator, so that the discharge of all of the water collected in the anode circuit only requires one line element 13 and a valve 14. This significantly reduces the number of components required and in particular the number of interfaces which require complex sealing arrangements if hydrogen-carrying lines are involved.

In this configuration, at least one of the water separators 8, 10—in any case the water trap 8—is designed as an integrated assembly 16 with the recirculation delivery device 11. This integrated assembly 16 can be seen in FIG. 2. The configuration is illustrated in a highly diagrammatic way. It essentially consists of the recirculation fan 11, which comprises an impeller 17 and a typically electric drive 18 for the impeller 17. The integrated assembly 16 further comprises the water trap 8, which is shown here in schematic cross-section. As the arrow indicates, the gas stream flows from the region of the main separator 10 into the region of the impeller 17 and is delivered by the latter into the region of the water trap 8. There it is mixed with fresh hydrogen flowing in at a geodetically lower level from the region of the compressed-gas accumulator 6 or the shut-off valve 7 respectively. Via suitable built-in parts 19 acting as splash guards, which may consist of baffles and/or knitted fabrics as indicated schematically in the drawing, the mixed gas stream arrives in the upper part of the water trap 8, leaving behind the condensed-out liquid droplets, and can there flow towards the anode region 3. By means of the inflow of the fresh hydrogen in a region having a very low geodetic level when using the water trap 8 as intended, and by means of the inflow of the recirculated gas stream from the region of the impeller at a comparable or slightly higher geodetic level and the discharge of the mixed gas stream towards the anode region 3 at a significantly higher geodetic level, it can be ensured relatively safely and reliably that condensed-out liquid droplets remain in the region of the water trap 8 and are not drawn into the anode region 3, where they could clog gas supply passages to the diaphragms and cause blockages by ice formation at temperatures below freezing point.

The water trap 8 also has two connections 20 in its upper region, which may, for example, be used to connect a pressure sensor or a differential pressure sensor. This integrated configuration results in an assembly 16 that operates simply and efficiently and requires a minimum of interfaces. It is particularly reliable when operating at temperatures below freezing point, because the freezing of the impeller 17 in particular and the freezing of any line elements between the components can largely be avoided.

In addition to the embodiment shown in FIG. 2, the main separator 10 could conceivably be integrated into the assembly 16 as well, for example by placing it below the water trap 8 and in this case repositioning the electric motor 18 below the impeller, resulting in a very compact integrated assembly 16.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A fuel cell system, comprising:
an anode circuit configured to recirculate unused gas from an anode region of a fuel cell via a recirculation delivery device into the anode region;
at least one liquid separator integrated with the recirculation delivery device to form an assembly, the at least one liquid separator being arranged in the anode circuit,
wherein the system is configured so that fresh hydrogen is supplied to the anode region by feeding the hydrogen into the liquid separator.

12. The fuel cell system according to claim 11, wherein the liquid separator integrated with the recirculation delivery device is located downstream of the recirculation delivery device in a direction of flow of the recirculated unused gas.

13. The fuel cell system according to claim 11, further comprising:
a second liquid separator in the anode circuit, the second liquid separator is connected with the first liquid separator, the second liquid separator is located upstream of the recirculation delivery device in a direction of flow of the recirculated unused gas.

14. The fuel cell system according to claim 13, wherein the system is configured so that liquid is diverted from the first liquid separator to the second liquid separator via a connection.

15. The fuel cell system according to claim 13, wherein the first and second liquid separators are part of an integrated assembly in the recirculation delivery device.

16. The fuel cell system according to claim 11, wherein the supply of fresh hydrogen is arranged at a geodetic level in the first liquid separator that is lower than a transfer of mixed gas streams to the anode region.

17. The fuel cell system according to claim 16, wherein the supply of the recirculated gas into the first liquid separator is arranged at a geodetic level lying between the supply of the fresh hydrogen and the transfer of the mixed gas streams.

18. The fuel cell system according to claim 14, wherein an entire amount of liquid in the region of the anode circuit is discharged from the region of the anode circuit via a line element with at least one valve device from a region of the second liquid separator.

19. The fuel cell system according to claim 13, wherein at least one of the first and second liquid separators includes a splash guard.

20. The fuel cell system according to claim 11, wherein the fuel cell system is configured to supply electric energy to drive units or secondary loads.
